(19) United States
(12) Patent Application Publication
(10) Pub. No.: US 2018/0097756 A1
(43) Pub. Date: Apr. 5, 2018

(54) OTT MESSAGING SERVICE AND SMS/MMS AGGREGATION ENGINE

(71) Applicant: SALESFORCE.COM, INC., San Francisco, CA (US)

(72) Inventor: Eugene Lee Lew, Olney, MD (US)

(21) Appl. No.: 15/713,679

(22) Filed: Sep. 24, 2017

Related U.S. Application Data
(60) Provisional application No. 62/403,841, filed on Oct. 4, 2016.

(51) Int. Cl. H04L 12/58; H04L 29/06; G06Q 30/00

(52) U.S. Cl. CPC H04L 51/066; H04L 51/36; G06F 17/289; H04L 63/08; G06Q 30/01; H04L 51/30

(57) ABSTRACT

A method and system enables communications with a CRM system via SMS/MMS and OTT messaging systems and formats.

### FIELD OF THE INVENTION

The present invention relates to Customer Relations Management (CRM) systems and communications via SMS/MMS messaging and multiple Over-The-Top (OTT) service providers.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which, in and of themselves, may also be inventions.

Social networking and business networking influence the way people communicate. Because of the influence of social media on the way people communicate, there are many social networks being developed and used by users throughout the world. For example, Facebook®, MySpace®, Linkedin®, Google+®, Twitter®, Chatter®, WhatsApp and other social networks have been created and developed in response to the social media craze.

Conventional Customer Relations Management (CRM) systems generally provide a web-based customer communications between users and customers. Enterprises have long had to deal with different ways that its customers communicate with them (e.g., paper, voice, fax, email, IM, etc.) and could never really realize a process to collect and collate all of the communications channels' data into the enterprise CRM system. Voice communication is a particularly difficult form of communication to integrate within the CRM system and the introduction of Internet Protocol (IP) and mobile messaging services including SMS/MMS text messaging, and proprietary systems such as Facebook, WhatsApp, WeChat, etc., only compound the problem.

Enterprises have long had to deal with different ways that its customers communicate with them (e.g.—paper, voice, fax, email, IM, etc.) and could never really realize a way to collect and collate all of the communications channels' data into its CRM system. Voice communications and the introduction of IP and mobile messaging services from SMS/MMS to proprietary systems such as Facebook, WhatsApp, WeChat, etc., only compound the integration problem.

Previous attempts have only addressed a single communications channel such as voice only, email only, fax only, paper only, etc. The same challenges exist with a multitude of proprietary OTT services (Facebook, Instant Messenger, Viber, WeChat, etc.) as well as hybrid SS7/IP based SMS/MMS platforms. There appears to be a shift towards mobile messaging communication. Because of this shift toward mobile communications that is not primarily voice based, enterprise based CRM systems will require the ability to collect and collate all its users' and customers' mobile messaging communications in addition to email, IM and other IP based communications.

### SUMMARY OF THE INVENTION

In accordance with embodiments disclosed herein, a CRM system combines a communications processing/message aggregation engine and databases in conjunction with a CRM system to process disparate messaging technologies (OTT and SMS/MMS). Such a system and techniques shift the ‘value’ and ‘intelligence’ from the individual OTT and SMS/MMS systems to the CRM in combination with the aggregation engine and database by incorporation/integration into the CRM. For example, the value of Facebook Messenger compared to SMS/MMS or other OTT system is minimized when the Enterprise CRM can communicate and process/archive/analyze all of its customer or user data regardless of the customer or user messaging medium (also referred to as a channel). Multiple fragmented messaging silos (i.e., single channel implementations) can be eliminated by a CRM system in combination with this an aggregation and database engine integral to the CRM platform.

In one embodiment, the applications of customers of a company function as a user interface (UI). The CRM system also facilitates the use of OTT applications for its own employees to interact with the CRM system and the company's customer. Effectively, every messaging app and social network functions as a UI to the CRM system.

Even though consumers sometimes use social media to air their grievances with companies, with text messaging consumers can achieve a satisfactory resolution to a support issue, versus simply publicly posting a complaint via social media (e.g., Twitter or Facebook). Social media simply doesn't provide the immediacy, intimacy or impact of a live text-based conversation.

Enabling a CRM to communicate via SMS in addition to its traditional web based communications is achieved in accordance with one embodiment by a method for integrating messaging into a CRM system including: receiving a message for transmission, authenticating a source of the message, identifying source format and type of the message, decrypting message if encrypted, looking up destination format and type capabilities of a destination, converting to supported and compatible type if not supported and compatible, storing and archiving if requested, logging message metadata, logging designated message data components with CRM and performing context analysis on message. The method further includes determining whether message is an A2P/Broadcast or notification type message, processing the message as a broadcast message in response to determining that the message is an A2P/Broadcast or notification type message, determining whether recipient has elected to receive messages, forwarding message to destination in response to determining that recipient has elected to receive messages and acknowledging successful delivery if requested.

Such a method solves a problem that has not been solved yet in a manner that allows CRM systems to seamlessly aggregate multiple OTT messaging channels and SMS/MMS text conversations between customers and users into what appears to be a single communications channel.

In a further embodiment, a technique for integrating messaging into a CRM system includes: preparing a message for transmission from the CRM to a customer destination, identifying source format and type of the message, selecting a recipient channel, determining if the selected recipient channel is supported, converting the message to a supported selected channel compatible format, encrypting message if required by the selected recipient channel or the customer destination and forwarding the message to the customer destination. Such a technique can improve marketing analysis, customer profiling, financial communications and capacity planning in conjunction with a CRM system (e.g., CRM systems provided by Salesforce®.

Other embodiments of the invention that are disclosed herein include software programs to perform the steps and operations summarized above and disclosed in detail below. One such embodiment comprises a computer program product that has a non-transitory computer-readable medium including computer program logic encoded thereon that, when performed in a computerized device having a coupling of a memory and a processor and a display, programs the processor to perform the operations disclosed herein. Such arrangements are typically provided as software, code and/or other data (e.g., data structures) arranged or encoded on a computer readable medium such as an optical medium (e.g., CD-ROM), hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained herein. Other configurations include web applications, browsers, IP applications and data enabled device applications as will be explained in more detail. It is to be understood that the features of the messaging hub and CRM can be embodied strictly as a software program, as software and hardware, or as hardware alone such as within a single processor or multiple processors, or within an operating system or within a software application.

### BRIEF DESCRIPTION OF THE DRAWINGS

The foregoing and other objects, features and advantages of the invention will be apparent from the following more particular description of embodiments of the invention, as illustrated in the accompanying drawings and figures in which like reference characters refer to the same parts throughout the different views. The drawings are not necessarily to scale, with emphasis instead being placed upon illustrating the embodiments, principles and concepts of the invention. These and other features of the invention will be understood from the description and claims herein, taken together with the drawings of illustrative embodiments, wherein

FIG. 1 is a schematic illustration of a messaging hub interoperating with a CRM system to provide unified communications services in conjunction with a network environment/messaging infrastructure in accordance with one example embodiment disclosed herein;

FIG. 2 is a more detailed schematic illustration of the messaging hub and messaging infrastructure of FIG. 1;

FIG. 3 illustrates details of an embodiment of the messaging hub of FIG. 1 including details of the message aggregation and an interface to a CRM system;

FIGS. 4-6 are flow charts of processing steps performed for the operation of the messaging hub in conjunction with the CRM system of FIG. 1.

### DETAILED DESCRIPTION

Different formats of various OTT proprietary platforms as well as non-standard SMS/MMS texting communication make integration of each channels' data into what appears to be a single channel on multiple devices very difficult. Analysis of all of this data is similarly difficult.

To solve this problem, embodiments herein disclose a messaging hub including an aggregation engine that interfaces to various OTT messaging services and the SMS/MMS infrastructure and performs translations, conversions, filtering and other necessary functions to provide a consistent communications system and interface to an Enterprise CRM system.

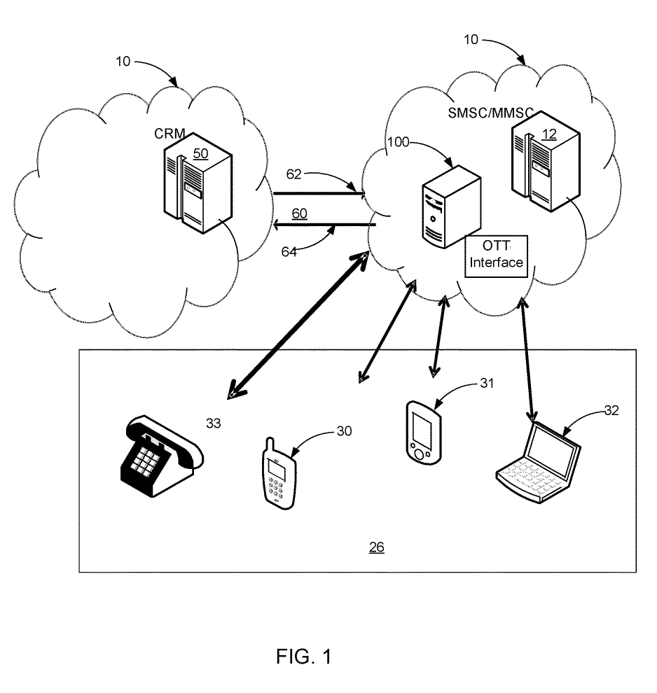

Now referring to FIG. 1, an exemplary messaging hub 100 operates in network environment 10 and relay messages between user devices 26 and a CRM system 50. User devices 26 include, for example, a mobile phone 30, a smartphone or WiFi phone 31 a laptop 32 a traditional land line phone 33 and other data enabled devices (not shown) such as a netbook and a tablet. The smartphone 31 can include a location device, for example a built in GPS (or other location device or location software). The messaging hub 100 communicates with the CRM system 50, in one embodiment, over a secure connection 60 (e.g., a VPN connection). It is also understood that the CRM system 50 and the messaging hub 100 could be integrated together. The CRM system 50 generally includes multiple databases and a web interface (not shown). In one embodiment, the messaging hub 100 and CRM system 50 communicate data, messages and OTT channel communication data over the secure connection 60.

In operation, the messaging hub 100 establishes a secure connection to a local short message service center/multimedia message service center SMSC/MMSC 12 and the data adapters (communication interfaces) 62 and 64 of CRM system 50. The SMSC/MMSC 12 is a network element in the network environment 10. The SMSC/MMSC 12 purpose is to store, forward, convert and deliver SMS/MMS messages. The messaging hub 100 also establishes secure connections (either directly or indirectly through APIs) to various OTT providers. The messaging hub 100 identifies a telephone numbers and authentication information for various OTT accounts used by the CRM system 50.

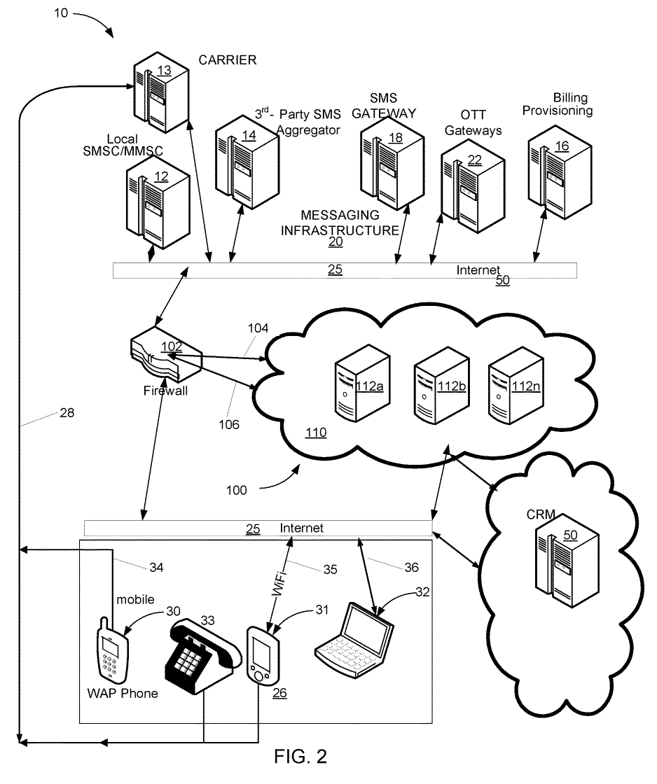

Now referring to FIG. 2, the exemplary messaging hub 100 operates in the network environment 10 which includes global messaging infrastructure 20. The messaging hub 100 includes one or more processors 112a-112n and is coupled to the network environment 10 and global messaging infrastructure 20 through a firewall 102. The firewall 102 is typically located at a messaging hub 100 hosting facility. The global messaging infrastructure 20 includes, but is not limited to, a local Short Message Service Center / Multimedia Messaging Service Center (SMSC/MMSC) 12, a third party SMS/MMS aggregator 14 (also referred to a SMS/MMS aggregator 14), a billing and provisioning system 16, an SMS/MMS Gateway (SMS/MMS-GW) 18, OTT messaging gateways 22 and a cellular phone infrastructure 28. Other components of the global messaging infrastructure 20 include an external (Global) SMSC/MMSC network 13 and additional SMS/MMS-Gateways and other SMSCs/MMSCs and billing and provisioning systems provided by additional mobile carrier service providers (not shown). The local SMSC/MMSC 12 and the billing and provisioning system 16 are typically operated by a mobile carrier service provider. A Global SMSC/MMSC network is typically operated by multiple mobile carriers 13 and third parties. The OTT messaging gateways 22 include connections to IM services, for example AOL instant messenger (AIM), Yahoo Messenger, Windows Live Messenger, WhatsApp, Jabber, Skype, Tencent QQ, ICQ and GoogleTalk (gTalk), and other networks such as Facebook and Twitter.

In one embodiment, the messaging hub 100 communicates with the systems in the global messaging infrastructure 20 (e.g., local SMSC/MMSC 12, the third party SMS/MMS aggregator 14 and the billing and provisioning system 16) using various network protocols including the Short Message Peer-to-Peer (SMPP) protocol, Hypertext Transfer Protocol (HTTP), Wireless Application Protocol (WAP), Signaling Transport (SIGTRAN) protocol or SS7 protocol. The SMPP protocol is a telecommunications industry protocol for exchanging SMS messages between SMS peer entities. The MM4 and MM7 protocols are telecommunications industry protocols for exchanging MMS messages between MMS peer entities. The HTTP and WAP protocols are a telecommunications industry protocols for exchanging SMS/MMS messages between SMS/MMS server and client entities.

In this embodiment, the link between the messaging hub 100 and the global messaging infrastructure 20 is secured by the firewall 102 using a virtual private network (VPN) connection with HTTPS using 128-bit or higher encryption, for example, 1024 bit (3DES-SHA1) encryption. Messages are transferred over SMPP link 104 and provisioning and single sign on (SSO), XML and SOAP messages and other control traffic are interchanged over control link 106. In another embodiment, messages are transferred over SIGTRAN (SS7 over IP) depending on the connection (e.g., a connection to a European Mobile Operator).

The messaging hub 100 is connected via the Internet 25 or a dedicated connection to the global messaging infrastructure 20 that relays messages between existing customer equipment, for example, a mobile phone 29, a data enabled mobile phone 30, a data enabled WiFi phone 31 and other data enabled devices (not shown) such as a laptop, netbook, tablet and a smart phone. The mobile phone 29 can be connected to the messaging hub 100 over the cellular phone infrastructure 28 through the local SMSC/MMSC 12 using an SMS protocol. The messaging hub 100 is connected via the Internet 25 or a dedicated connection to the CRM system 50 of one or more business enterprises. The Global SMSC/MMSC network 13 is also connected to the cellular phone infrastructure 28. The mobile phone 30 can be connected to the messaging hub 100 over the cellular phone infrastructure 28 using a data connection provided by OTA/WAP protocols. A data enabled WiFi phone 31 can be connected to the messaging hub 100 via a WiFi connection to the Internet. It is understood that a mobile phone can be data enabled via a wireless carrier connection and/or a WiFi connection. The data enabled WiFi phone 31 is sometimes referred to as a dual mode phone if it can also connect over WAP. The messaging hub 100 can also connect to the landline phone 33 to record and convert speech into text for further processing.

The messaging hub supports 2-way communications between the users of the CRM system and the customers of the users. In operation and as described below in more detail, a customer or a user can send a text messages to the CRM system 50 using the a CRM's 800 number or any other number provisioned for SMS messages to be directed to the CRM. The customer can use any device, application and any communications path (e.g., OTA or IP connection) which is enabled for SMS messaging. After the provisioning process, messages sent from the customer are directed through the global messaging infrastructure 20 by an SMS/MMS aggregator 14, local SMSC/MMSC 12 or a carrier 13 to the messaging hub 100. The messaging hub 100 determines that the message is intended for a particular CRM, communicates with the CRM system 50 with corresponding applications and the message is delivered to the CRM system 50 as described in more detail below. The customers and user can communicate with each other or application in the CRM cloud either in SMS/MMS format or in one of the formats of the various OTT providers.

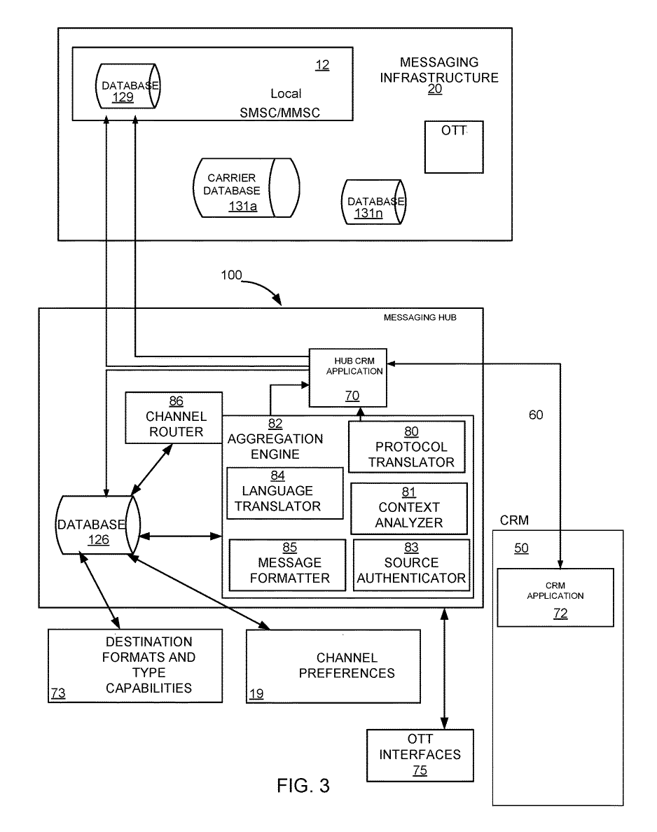

FIG. 3 illustrates further details of the provisioning process and communication between the messaging hub 100 and the CRM system 50. The messaging hub 100 includes a Hub CRM application 70 which communicates with a corresponding CRM application 72 in the CRM system 50 over the secure connection 60. The messaging hub 100 includes a database 126 that includes destination formats and type capabilities 73 and channel preferences 19 and also collects, stores, sorts, collates and provides analysis data of the various OTT and SMS/MMS data. The messaging hub 100 includes one or more OTT interfaces 75 to receive messages from OTT sources. The messaging hub 100 includes an aggregation engine 82 which acts as a central gateway to:

interpret different protocols using protocol translator 80;

provide format conversion using message formatter 85;

authenticate identities with source authenticator 83;

route messages (in both directions) to appropriate channels using channel router 86;

translate messages using language translator 84, and

ensure both ends (sending and receiving) are able to accept and read/view the messages sent to/from the other.

Different data types processed by the aggregation engine 82 include, but are not limited to: digital voice, voice converted into text, text, images, video and combinations of the above.

Database 126 provides a repository that the Hub CRM application 70 uses in conjunction with CRM application 72 to archive messages and analyze traffic patterns based on any variable possible of any and cumulative collection of the different communication channels. In operation, Hub CRM application 70 queries database 126 to determine a customer/user's collection of devices to:

provide the enterprise with greater intelligence on the user's device(s) abilities for various functions (screen resolution, audio capabilities, camera resolution, bandwidth, etc.);

provide the user/customer with a richer experience than LCD (lowest common denominator) based on the user's devices (although the LCD must sometimes be used);

analyze user's words, sentences, diction, grammar using Artificial Intelligence (AI) techniques, known in the art, to route messages to appropriate Enterprise personnel as well as flagging user for reverse communications (marketing, support, follow-up) based on the analysis; and

maintain an ‘identity state table’ for users to identify and track a user's identity and probable ‘multiple’ identities (multiple channels: IP services, mobile SMS/MMS, voice).

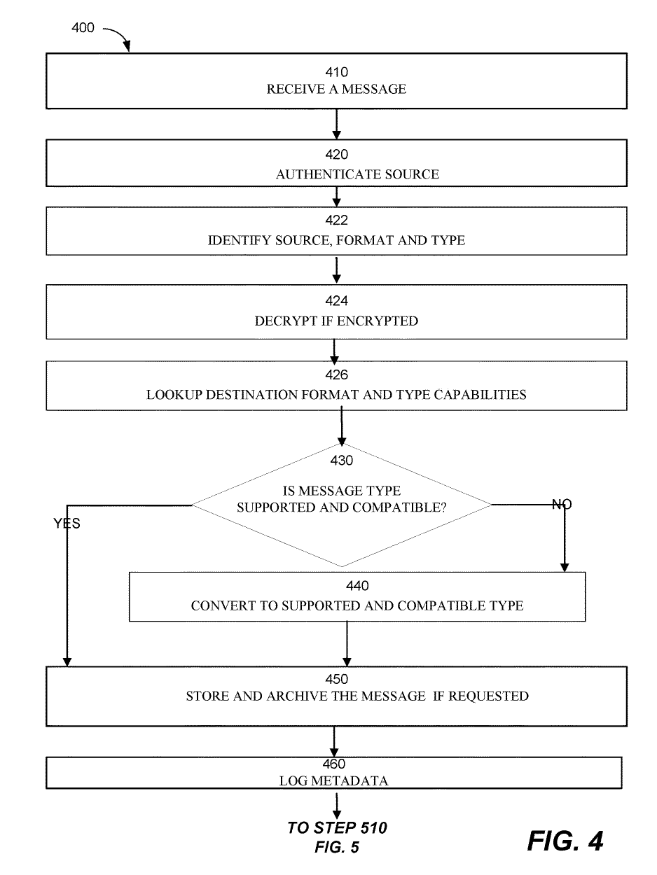

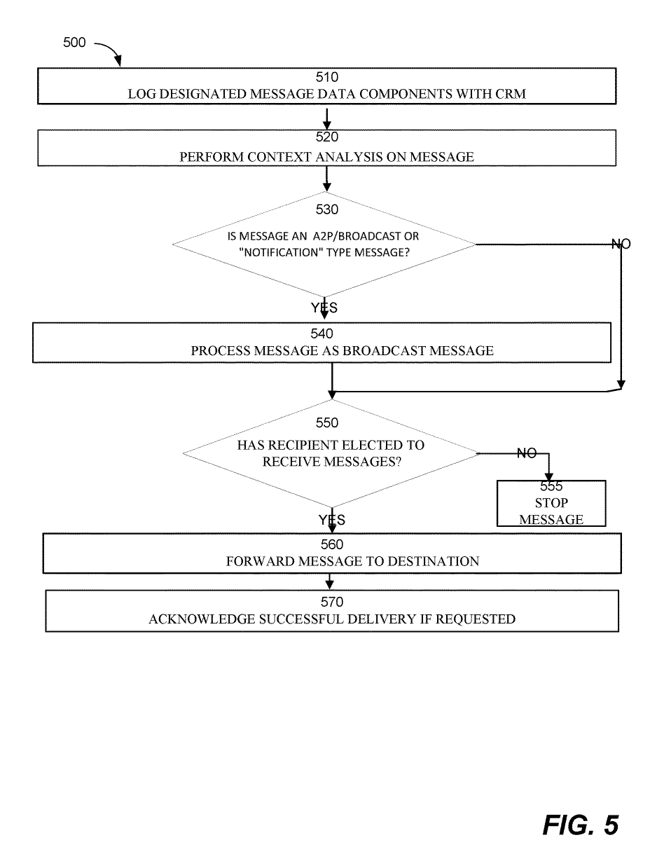

In FIG. 4, flowchart 400 diagrams the overall process of receiving a message from the CRM for delivery to a user or a customer. In step 410, a message for transmission is received by the messaging hub 100. In step 420, the source of the message is authenticated. In step 422, the source format and type of the message is identified. In step 424, the message is decrypted if it was encrypted. In step 426, the destination format and type capabilities of a destination are looked up. In step 430, it is determined whether the message type is a supported and compatible type, if not the message is converted to a supported and compatible type in step 440. In step 450, the message is stored and archived if requested by the user or customer. In step 460, metadata corresponding to the message is logged. The message metadata is used for context processing by the context analyzer 81 and later for historical analysis. Processing continues in step 510 (FIG. 5).

FIG. 5 diagrams further steps in the process of overall process of receiving a message for delivery to a user or a customer. In step 510, designated message data components are logged with the CRM system 50. Portions of the message data components are use to update the databases in the CRM system 50. In step 520, context analysis is performed on the message. In step 530, it is determined whether the message is an Application to Person (A2P)/Broadcast or notification type message. If the message is an A2P/Broadcast or notification type message, processing continues at step 540 where the message if processed as a broadcast message, otherwise processing continues at step 550. The broadcast message is sent to a group or a list and is only sent if the customer has opted-in to receive these types of messages. In step 550, it is determined whether recipient has elected to receive messages. If the recipient has elected to not receive messages, processing of the message stops at step 555, otherwise processing continues at step 560. In step 560, the message is forwarded to the destination and finally in step 570 if requested successful delivery of the message is acknowledged in response to determining that acknowledgment is requested.

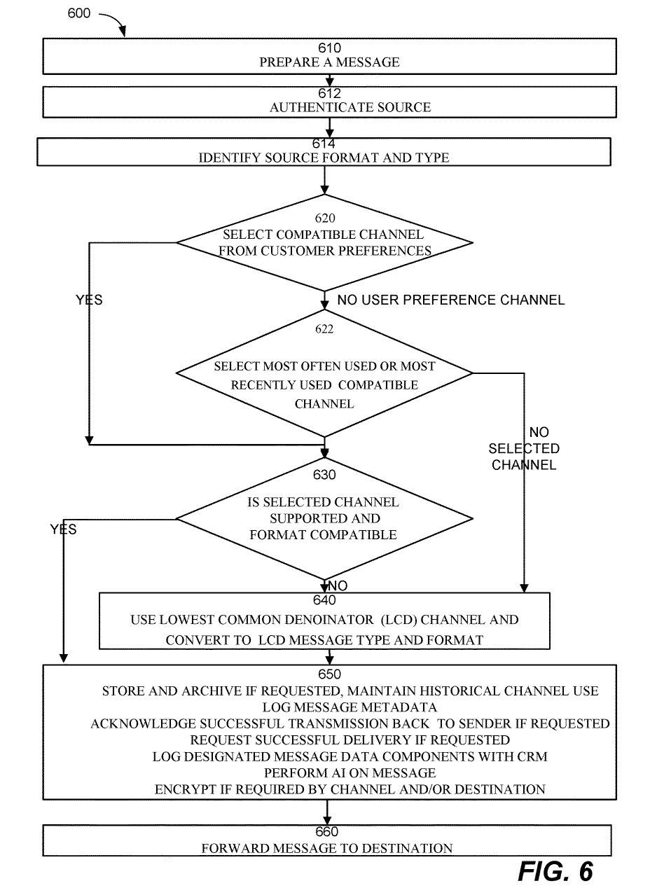

FIG. 6 diagrams the process of integrating messaging into a CRM system and sending an outgoing message to a user or a customer. In step 610, a message is prepared for delivery to a customer destination. In step 612, the source of the message is authenticated. In step 614, the source format and type of the message is identified for compatibility. In step 620, a compatible channel (also referred to a communications channel) from customer preferences is selected. In one embodiment, the recipient communications channel preferences, format and type capabilities are looked up in database 126 which includes customer preferences for channels and formats to use. If a customer preferred channel is found, the process continues at step 630 to check channel support and message format compatibility. If no customer preferred channel is found, the process continues at step 622.

In step 622, using historical data, (i.e., history of previously selected recipient channels) the most often used channel or the most recently used channel is selected. It is understood, that the order in which a channel is selected or the method to select a channel can be a user preference or varied by a specific embodiment. In one embodiment, the messaging hub 100 maintains historical records of which messaging services (e.g.—SMS, specific OTTs) a customer or user has used in communicating with the CRM 50, and the hub 100 will use the historical data to select the most often used channel compatible with the message format. If the most recently used channel is not available, this embodiment will attempt to use the most recently used channel. After a channel is selected, it is determined whether the channel is compatible with the message format (e.g., digital voice, (text, graphics types, video, forms, etc.) in step 630. If there is no historical record channel, customer preferred channel available or a channel which is format compatible, the hub 100 will use the “lowest common denominator” channel and format (e.g., an SMS text message or an email).

For example, if a customer has a preference for message delivery through a social network using an app and a message is to be delivered with an attachment which is too large for the app then another delivery channel is needed or the message would need modification. In this case the aggregation engine 82 in conjunction with the CRM system using information in database 126 might use another preferred channel for delivery or the attachment might be converted into a different format which would allow delivery to the initial selected channel.

In step 630, it is determined whether the selected recipient channel is supported and compatible with the message format of the message to be sent to the customer. If the selected channel is supported by the messaging hub 100 and the customer still supports the channel then processing continues at step 650 to log and send the message, otherwise processing continues at step 640, where a lowest common denominator (LCD) channel is used and in some cases the message is converted to an LCD message type and format (i.e., a supported channel and supported selected channel compatible format) in response to determining that there is no historical compatible recipient channel and determining that there is no there is no compatible customer preference recipient channel. Finally the message is sent in step 650 as described below.

In step 650, the message is stored and archived if requested; historical channel use is maintained for future channel selection, message metadata is logged; successful transmission is acknowledged back to message source if requested; designated message data components are logged with the CRM 50; context analysis on the message is performed by the context analyzer 81 and the message is encrypted if required by the channel and/or destination. Finally in step 660, the message is forwarded to the destination using one of the OTT interfaces 75 if necessary.

While configurations of the system and method have been particularly shown and described with references to configurations thereof, it will be understood by those skilled in the art that various changes in form and details may be made therein without departing from the scope of the invention. As an example, the order of processing steps in the flow charts is not limited to the order shown herein. Accordingly, the present invention is not limited by the example configurations provided above.

What is claimed is:

1. A computer-implemented method for integrating messaging into a Customer Relations Management (CRM) system comprising:
receiving a message for transmission to a CRM;
authenticating a source of the message;
identifying source format and message type of the message;
looking up a destination format and type capabilities of a destination;
determining whether the message type is a supported and compatible type;
converting the message to a supported and compatible message type in response to determining
the message type is not a supported and compatible type; and
forwarding the message to the destination.

2. The method of claim 1 further comprising decrypting message in response to determining that the message is encrypted.

3. The method of claim 1 further comprising:
archiving the message in response to determining that message archiving is requested;
logging message metadata; and
logging designated message data components with the CRM.

4. The method of claim 1 further comprising performing context analysis on the message.

5. The method of claim 1 further comprising:
determining whether the message is an A2P/Broadcast or notification type message; and
processing the message as a broadcast message in response to determining that the message is an A2P/Broadcast or notification type message.

6. The method of claim 1 further comprising determining whether recipient has elected to receive messages;
forwarding the message to the destination in response to determining that recipient has elected to receive messages; and
acknowledging successful delivery in response to determining that acknowledgment is requested.

7. A computer-implemented method for integrating messaging into a Customer Relations Management (CRM) system comprising:
preparing a message for transmission from the CRM to a customer destination;
identifying source format and type of the message;
selecting a recipient channel;
determining if the selected recipient channel is supported;
converting the message to a supported selected channel compatible format;
encrypting message if required by the selected recipient channel or the customer destination; and
forwarding the message to the customer destination.

8. The method of claim 7 further comprising authenticating a source of the message.

9. The method of claim 7, wherein selecting a recipient channel further comprises selecting a channel from customer preferences.

10. The method of claim 7 further comprising maintaining a history of previously selected recipient channels.

11. The method of claim 10, wherein selecting a recipient channel further comprises using the history of previously selected recipient channels to select one of:
a most often used channel; and
a most recently used channel.

12. The method of claim 7, wherein selecting a recipient channel further comprises selecting a lowest common denominator (LCD) channel in response to one of
determining that there is no historical compatible recipient channel; and
determining that there is no compatible customer preference recipient channel.

13. The method of claim 7, wherein selecting a recipient communications channel further comprises converting the message to a supported channel and compatible format.

14. A messaging hub comprising:
a HUB CRM application coupled to a database;
an OTT interface; and
an SMS/MMS aggregation engine comprising a source authenticator.

15. The messaging hub of claim 14, further comprising a message formatter.

16. The messaging hub of claim 14, further comprising a context analyzer.

17. The messaging hub of claim 14, further comprising a protocol translator and a language translator.

18. The messaging hub of claim 14, further comprising a channel router to send and receive messages to and from appropriate channels.
